(19) United States
(12) Patent Application Publication
(10) Pub. No.: US 2010/0173582 A1
(43) Pub. Date: Jul. 8, 2010

(54) APPARATUS OF ANALIZING THE CONSTRUCTION PRODUCTIVITY USING RFID BASED ON THE WIRELESS COMMUNICATION AND THEREOF

(76) Inventor: Seung-Woo Han, Incheon (KR)

Correspondence Address: LUCAS & MERCANTI, LLP, 475 PARK AVENUE SOUTH, 15TH FLOOR, NEW YORK, NY, 10016, US

(21) Appl. No.: 12/441,561

(22) PCT Filed: Oct. 9, 2008
(86) PCT No.: PCT/KR2008/005935

§ 371 Date: Mar. 17, 2009

(30) Foreign Application Priority Data
Oct. 11, 2007 (KR) 10-2007-0102498

(51) Int. Cl. H04B 5/00; H04Q 5/22

(52) U.S. Cl. 455/41.1; 340/10.1

(57) ABSTRACT

The present invention relates to a real-time construction productivity analyzing apparatus and method using an RFID based on wireless communication. The present invention provides an apparatus and method that can provide a systematic construction management system through the real-time productivity analysis and the real-time monitoring for each process of the construction field, and can detect a productivity-reducing factor in real time by integrating IT fields such as wireless communication technology and RFID technology, so that the near target productivity can be achieved by prompt treatment.

The real-time construction productivity analyzing apparatus includes: an RFID tag including an ID code for identification of each equipment for construction work and attached to each equipment; a tag data management device for reading the ID code of the RFID tag in order to check a cycle time of each equipment in each process of the construction work, integrating the read time and position of the RFID tag and the ID code data of the RFID tag, and transmitting the integrated data; a central server for receiving the time and position data and the ID code of the RFID tag from the tag data management device and updating the data in real time to monitor the productivity in real time; and a database for storing the prestored data and the real-time input data of the central server.

### CROSS-REFERENCES TO RELATED APPLICATION

This patent application claims the benefit of priority under 35 U.S.C. §119 from Korean Patent Application No. 10-2007-102498 filed on Oct. 11, 2007, the contents of which are incorporated herein by reference.

### BACKGROUND OF THE INVENTION

1. Field of the Invention

The present invention relates to an apparatus and method for analyzing construction productivity in real time by using a Radio Frequency IDentification (RFID) based on wireless communication.

2. Description of the Related Art

In general, since a process-by-process plan for construction is an important factor determining the success or failure of a construction project, a suitable process plan is made by collecting information about the field conditions and the corresponding processes and analyzing the expected productivity.

For achievement of a production yield according to the ideal process plan, supervision and management are done in the field and the productivity of the corresponding process is detected and calculated day by day. If a productivity-reducing factor occurs, it is checked in detecting the day-by-day productivity after termination of the corresponding work.

For calculation of the day-by-day productivity, a working time in each day is measured, the number of process cycles performed during the working time is measured, and a production yield is calculated using the number of process cycles performed for a predetermined time in each day.

For example, if each of 7 trucks performs 48 cycles (excavating, loading, carrying, and unloading) for 8 hours per day and a one-time load of each truck is 20 m³, the productivity per day is 326 cycles/day and the load productivity pet day is 6720 m³/day.

The productivity per hour and the load productivity per hour are calculated to be 42 cycles/hour and 840 m³/hour, respectively. The calculated productivities are set as standard data for civil construction in the planning stage, and a suitable process plan is made accordingly.

However, since the above productivities are calculated without consideration of a waiting time, i.e., a work delay time of the construction equipment in the actual field, they are calculated to be higher than the actual productivities. Such a simple arithmetic productivity estimation method fails to accurately reflect the productivity of an actual ongoing process, does not consider a plurality of parameters, fails to cope with unpredictable factors in real time, and fails to provide management by an objective and systematic system, thus wasting time and human resources.

### SUMMARY OF THE INVENTION

Accordingly, the present invention is directed to an apparatus and method for analyzing construction productivity in real time by using an RFID based on wireless communication that substantially obviate one or more of the problems due to limitations and disadvantages of the related art.

An object of the present invention is to provide an apparatus and method for analyzing construction productivity in real time by using an RFID based on wireless communication, which can implement a real-time product analysis of the equipment for each process of construction work.

Another object of the present invention is to provide an apparatus and method for analyzing construction productivity in real time by using an RFID based on wireless communication, which can establish a process capable of achieving a target production yield by detecting a productivity-reducing equipment in real time by using an RFID.

Another object of the present invention is to provide an apparatus and method for analyzing a construction productivity in real time by using an RFID based on wireless communication, which can receive RFID data wirelessly by using wireless communication.

Another object of the present invention is to provide an apparatus and method for analyzing construction productivity in real time by using an RFID based on wireless communication, which can implement a process system capable of achieving high productivity by detecting a productivity-reducing factor in real time by using an RFID system.

The present invention attaches an RFID tag to productivity-reducing main equipment on the basis of construction work modeling, detects the positions and times of the RFID tag at the start and end points of each process cycle, integrates the detected data, transmits the integrated detected data to a predetermined database through wireless or wired communication for real-time update, and analyzes variable productivity in real time, thus making it possible to eliminate a productivity-reducing factor promptly.

As described above, the present invention with the above structure can provide an organic connection so that the production yield detected during the construction work can be controlled to approach the target production yield set before the construction work. Also, the present invention integrates the IT field such as wireless communication with the construction field, thereby making it possible to increase the possibility of commercialization and practical use by using the preexisting network of the IT field. Also, the present invention can provide real-time analysis and prompt improvement on the basis of an objective and systematic system, thereby making it possible to advance the construction field management technology. Also, the present invention increases the productivity such as the utilization of human and time resources, thus making it possible to provide an efficient management system.

### BRIEF DESCRIPTION OF THE DRAWINGS

FIG. 1 is a block diagram of a real-time construction productivity analyzing apparatus using an RFID based on wireless communication according to an exemplary embodiment of the present invention.

FIG. 2 is a schematic block diagram illustrating an embodiment of an operation process of the real-time construction productivity analyzing apparatus of FIG. 1.

FIG. 3 is a block diagram of a real-time construction productivity analyzing apparatus using an RFID based on wireless communication according to another exemplary embodiment of the present invention.

FIG. 4 is a schematic block diagram illustrating an operation process of the real-time construction productivity analyzing apparatus of FIG. 3.

FIG. 5 is a schematic block diagram illustrating an operation process of the real-time construction productivity analyzing apparatus of FIG. 3.

FIG. 6 is a flow diagram illustrating a real-time construction productivity analyzing method using an RFID based on wireless communication according to an exemplary embodiment of the present invention.

1; Real-time construction productivity analyzing apparatus using RFID based on wireless communication

### DESCRIPTION OF THE SYMBOLS IN MAIN PORTIONS OF THE DRAWINGS

10: RFID tag

30: Tag data management device

31: RFID reader

32: Control unit

33: Time providing unit

34: Position providing unit

35: Memory

36: Near-field communication unit

36a: Wireless LAN

40: Wireless connection device

50: Central server

51: Near-field communication unit

51a: Wireless LAN card

53: Control unit

55: Memory

60: Central processing device

61: Near-field communication unit

61a: Wireless LAN card

63: Control unit

65: Long-distance communication unit

65a: CDMA

70: Database

80: Remote-control central server

81: Long-distance communication unit

81a: CDMA

83: Control unit

85: Memory

### DESCRIPTION OF THE PREFERRED EMBODIMENTS

To achieve these and other advantages and in accordance with the purpose of the present invention, as embodied and broadly described, there is provided a real-time construction productivity analyzing apparatus including: an RFID tag including an ID code for identification of each equipment for construction work and attached to each equipment; a tag data management device for reading the ID code of the RFID tag in order to check a cycle time of each equipment in each process of the construction work, integrating the read time and position of the RFID tag and the ID code of the RFID tag, and transmitting the integrated data; a central server for receiving the time and position data and the ID code of the RFID tag from the tag data management device and updating the data in real time to monitor the productivity in real time; and a database for storing the prestored data and the real-time input data of the central server.

According to another aspect of the present invention, there is provided a real-tithe construction productivity analyzing apparatus including: an RFID tag including an ID code for identification of each equipment for construction work and attached to each equipment; a tag data management device for reading the ID code of the RFID tag in order to check a cycle time of each equipment in each process of the construction work, integrating the read time and position of the RFID tag and the ID code of the RFID tag, and transmitting the integrated data to the near field; a central processing device for receiving the time and position data and the ID code data of the RFID tag from the tag data management device and transmitting the received data to the far field; a remote-control central server for updating in real time the data received from the central processing device to the productivity in real time; and a database for storing the prestored data and the real-time input data of the remote-control central server.

Preferably, the near-field communication unit of the tag data management device and the near-field communication unit of the central server use &wireless LAN.

Preferably; the long-distance communication unit of the central processing device and the long-distance communication unit of the remote-control central server use CDMA.

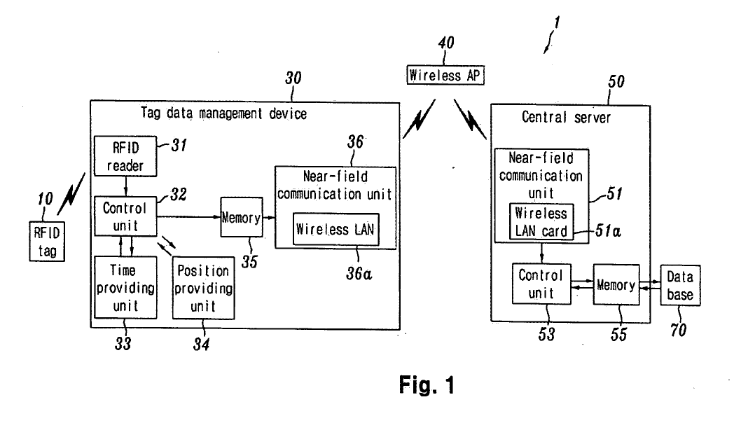

FIG. 1 is a block diagram of a real-time construction productivity analyzing apparatus using a Radio Frequency IDentification (RFID) based on wireless communication according to an exemplary embodiment of the present invention. Referring to FIG. 1, a real-time construction productivity analyzing apparatus 1 using an RFID based on wireless communication according to an exemplary embodiment of the present invention includes: an RFID tag 10 attached to identify each equipment for each process of construction work by using an ID code; a tag data management device 30 for checking a cycle time taken by each equipment in each process and managing the corresponding data; a central server 50 for monitoring the productivity in real-time by receiving data transmitted from the tag data management device 30; and a database 70 for storing and updating the data.

Herein, the RFID tag 10 is attached to a target object, i.e., an equipment for each process. The RFID tag 10 includes a small-sized chip containing information about the target object. The information is used in a management system in connection with various communication lines, such as wired communication and satellite communication, through an RFID reader 31.

In general, the RFID tag 10 includes an IC chip and an antenna, an ID code (i.e., an identification number) is stored in a storage unit in the IC chip, and a temporary storage unit is provided to receive a signal from the RFID reader 31 and transmit an ID code.

The RFID tag 10 may be a passive type to be supplied with power from the RFID reader 31, or may be an active type to transmit data by its own power.

The tag data management device 30 includes: the RFID reader 31 for reading an ID code of the RFID tag 10; a time providing unit 33 for outputting the read time of the RFID tag 10 in synchronization with the ID code read time of the RFID reader 31; a position providing unit 34 for outputting the position of the RFID reader; a control unit 32 for performing an output/control operation for transmission by receiving the read. ID code of the RFID reader 31, the output time of the time providing unit 33, and the output position of the position providing unit 34; a memory 35 for temporarily storing data output from the control unit 32; and a near-field communication unit 36 for transmitting the data through near-field communication.

Herein, if the RFID tag 10 is a passive type, the RFID reader 31 outputs a frequency to supply power to the RFID tag 10. Accordingly, the RFID reader 31 receives data from the RFID tag 10 and provides the data to the control unit 32.

In order to receive the ID code read time of the RFID reader 31, upon receiving the ID code from the RFID reader 31, the control unit 32 synchronizes the time providing unit 33 to output the ID code read time,

The reason for this is that when the equipment with the RFID tag 10 attached obtains the passing time of the RFID reader 31, the RFID reader 31 can detect the start and end times of the equipment and can detect the operation time of the equipment for one process, thus making it possible to estimate the productivity. Therefore, a control operation is performed to output the time to read the RFID tag 10 by the RFID reader 31.

The position providing unit 14 provides the position of the RFID reader 31. If the tag data management device 30 is a stationary type, the position providing unit 34 prestore the corresponding coordinates. If the tag data management device 30 is a mobile type, the position providing unit 34 cannot accurately detect the coordinates and thus synchronizes in the same mechanism as the time providing unit 33 to output the coordinates.

Preferably, the time providing unit 33 and the position providing unit 34 may be integrated into a Global Positioning System (GPS).

It is preferable that the memory 35 is configured to temporarily store the read ID code of the RFID reader 31, the output time of the time providing unit 33, the output position of the position providing unit 34. The reason for this is that as the RFID tag 10 moves, the RFID reader 31 at the start or end point of each process cycle receives the contents of the RFID tag 10 in real time. Therefore, the transmission-completed data may not be stored any more, and thus it is preferable that the memory 35 is implemented using a flip-flop memory device such as a Random Access Memory (RAM).

The near-field communication unit 36 is provided for data transmission for the case where the central server 50 is located in the near field. If the central server 50 is located in the far field, a long-distance communication module is further provided together with the near-field communication unit 36.

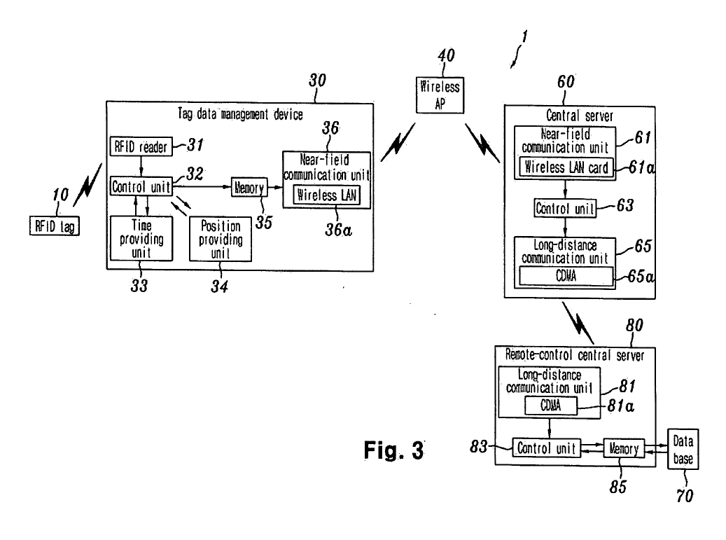

FIG. 1 illustrates the case where the near-field communication unit 36 and the central server 50 are located in the near field, and a description is made accordingly. The case where the central server 50 is located in the far field will be described later with reference to FIG. 3.

Herein it is preferable that the near-field communication unit 36 is implemented using a wireless LAN. The wireless LAN establishes a communication network using wireless transmission lines, such as electromagnetic waves or rays (infrared rays), and provides communication within a predetermined range. The wireless LAN can provide communication if only a wireless LAN card is installed in a personal computer (PC). Therefore, if the- central server 50 is located in the near field, it is preferable that the wireless LAN is used to implement the near-field communication unit 36.

For transmission of data from the near-field communication unit 36 to the central server 50, a wireless Access Point (AP) 40 is further provided to establish a wireless network within a predetermined range, so that the Internet can be used wirelessly within the predetermined range and the Internet service can be used through the LAN card within the network.

The central server 50 includes: a near-field communication unit 51 for receiving data transmitted from the tag data management device 30 through the wireless AP 40; and a control unit 53 for updating the cycle time of each equipment on the basis of data received from the near-field communication unit 51, analyzing the corresponding productivity, and storing data in the database 70.

Herein, it is preferable that a memory 55 is further provided to store data temporarily between the control unit 53 and the database 70.

The near-field communication unit 51 may be used as a wireless LAN by having a wireless LAN card 51a, to which the present invention is not limited.

The database 70 is provided to store and update the respective data received through the tag data management device 30, the wireless AP 40 and the central server 50. The database 70 is provided to optimize and store the cycle time of each equipment for each process of construction work.

The database 70 is provided to update the time and position at the operation start point of each equipment having the RFID tag 10 attached thereto, to compare the update result with optimized data, and to output data, which are input in real time and exhibits lower productivity than the optimized data, to the user in order to eliminate a productivity-reducing factor.

The central server 50 can check the productivity in real time on the basis of respective data input in real time to the database 70, and can detect the difference from the target production yield by comparison with the optimized productivity.

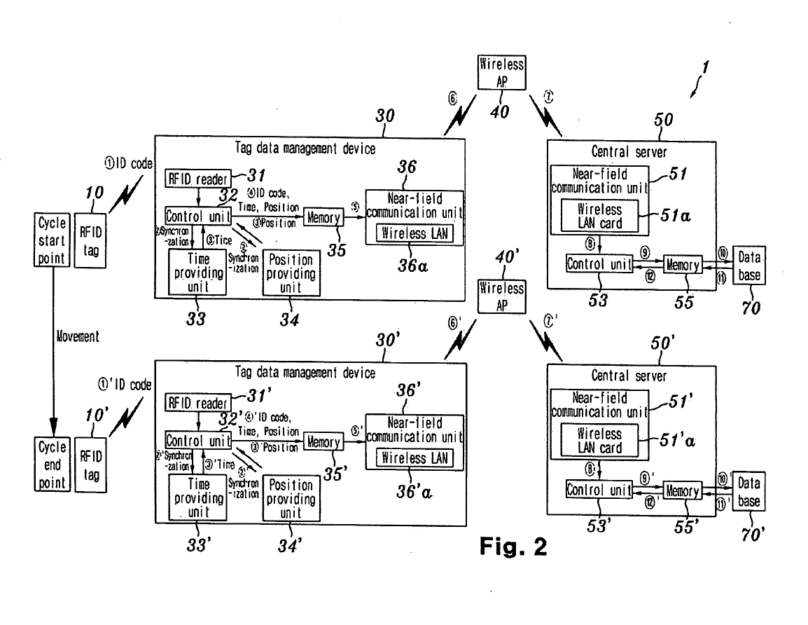

FIG. 2 is a schematic block diagram illustrating an embodiment of an operation process of the real-time construction productivity analyzing apparatus 1 of FIG. 1. Referring to FIG. 2, the operation process of the real-time construction productivity analyzing apparatus 1 starts as follows.

First, at a cycle start point, each equipment for each process transmits its own ID code by the RFID tag 10 attached to the equipment passing the cycle start point (\textcircled{1}).

Accordingly, when the RFID reader 31 transmits the ID code to the control unit 32 in order to be able to detect the work start time and position of each equipment for each process, the control unit 32 synchronizes the time providing unit 33 and the position providing unit 34 (\textcircled{2}) to output the passing time and position of the equipment (\textcircled{3}) integrates the ID code, the time and the position to temporarily stores the integrated data in the memory 35 (\textcircled{4}), and outputs the data to the near-field communication unit 36 in order to transmit the same to the central server 50 through the near-field communication unit 36 (\textcircled{5}).

Then, the near-field communication unit 36 transmits data through the wireless AP 40 that provides an access point for establishing a wireless network within a predetermined area (\textcircled{6}, \textcircled{7}), and the central server 50 receives the data and outputs the same from the near-field communication unit 51 to the control unit 53 (\textcircled{8}).

Also, the control unit 53 outputs the integrated data of the ID code, the time and the position to the memory 55 in order to temporarily store the integrated data before storing the same in the database 70 (\textcircled{9}), and the memory 55 outputs data to the database 70 in order to update data in real time (\textcircled{10}).

The real-time input data are not overwritten in the database 70 on the optima value of the equipment with the ID code, but are input in a paste manner for comparison while maintaining the optimal value.

That is, if there is no real-time input data, the first input data are overwritten for comparison with the optimal value data and the equipment having the same RFID tag 10 passes at the same cycle start point, the update is performed in an overwrite manner.

Then, the database 70 outputs prestored data and new input data to temporarily store the data in the memory 55 (\textcircled{11}), and the same is provided to the control unit 53 (\textcircled{12}).

Meanwhile, in order to check the time and position of an equipment with an RFID tag 10′ after completion of construction work, the RFID tag 10′ are read at a cycle end point that is a construction work end point of the equipment.

Herein, a symbol [symbol] is added to the corresponding reference symbol in order to discriminate the corresponding component for the cycle end point from the corresponding component for the cycle start point, and the components for the cycle end point are identical to the components for the cycle start point, except the tag data management devices 30 and 30′ and the wireless APs 40 and 40′.

That is, the tag data management devices 30 and 30′ are respectively provided for the cycle start point and the cycle end point, the RFID tags 10 and 10′ and the central servers 50 and 50′ are the same components, and the wireless APs 40 and 40′ may be provided differently according to the respective wireless networks.

At the cycle end point, the RFID tag 10′ transmits an ID code to the RFID reader 31′ (\textcircled{1}′). When the RFID reader 31′ transmits the ID code to the control unit 32′ in order to be able to detect the work end time and position of the equipment, the control unit 32′ synchronizes the time providing unit 33′ and the position providing unit 3.4′ (\textcircled{2}) to output the passing time and position of the equipment (\textcircled{3}′), integrates the ID code, the time and the position to temporarily stores the integrated data in the memory 35′ (\textcircled{4}′), and outputs the data to the near-field communication unit 36′ in order to transmit the same to the central server 50′ through the near-field communication unit 36′ (\textcircled{5}′).

Then, the near-field communication unit 36′ transmits data through the wireless AP 40′ that provides an access point for establishing a wireless network within a predetermined area (\textcircled{6}′, \textcircled{7}′), and the central server 50′ receives the data and outputs the same from the near-field communication unit 51′ to the control unit 53′ (\textcircled{8}′).

Also, the control unit 53′ outputs the integrated data of the ID code, the time and the position to the memory 55′ in order to temporarily store the integrated data before storing the same in the database 70′ (\textcircled{9}), and the memory 55′ outputs data to the database 70′ in order to update data in real time (\textcircled{10}).

Then, the database 70′ stores new input data and provides the data to the central server 50′ so that the central server 50′ calculated the productivity of the equipment by using the data stored at the cycle start point and the new input data stored at the cycle end point (\textcircled{11}).

Also, the central server 50′ temporarily stores the data in the memory 55′ and outputs data to the control unit 53′ in order to compare the optimized data with the data according to the newly-calculated productivity (\textcircled{12}).

Lastly, the control unit 53′ calculates the production yield by using the time and position at the cycle start point and the time and position at the cycle end point, compares the calculated production yield with the optimized data to determine whether the calculated production yield approaches the optimized production yield. If the production yield is relatively low, the control unit 53′ detects/analyzes a productivity-reducing factor and outputs the same to the user in order to eliminate the productivity-reducing factor.

FIG. 3 is a block diagram of a real-time construction productivity analyzing apparatus using an RFID based on wireless communication according to another exemplary embodiment of the present invention.

Referring to FIG. 1, a real-time construction 10 productivity analyzing apparatus 1 using an RFID based on wireless communication according to another exemplary embodiment of the present invention includes; an RFID tag 10 attached to identify each equipment for each process of construction work by using an ID code; a tag data management device 30 for checking a cycle time taken by each equipment in each process and managing the corresponding data; a central processing device 60 for receiving data transmitted from the tag data management device 30 and transmits the received to a remote-control central server 80; the remote-control central server 80 for monitoring the productivity in real-time by receiving data transmitted from the central processing device 60; and a database 70 for storing and updating the data.

Herein, the RFID tag 10 is attached to a target object, i.e., an equipment for each process. The RFID tag 10 includes a small-sized chip containing information about the target object. The information is used in a management system in connection with various communication lines, such as wired communication and satellite communication, through an RFID reader 31.

In general, the RFID tag 10 includes an IC chip and an antenna, an ID code (i.e., an identification number) is stored in a storage unit in the IC chip, and a temporary storage unit is provided to receive a signal from the RFID reader 31 and transmit an ID code.

The RFID tag 10 may be a passive type to be supplied with power from the RFID reader 31, or may be an active type to transmit data by its own power.

The tag data management device 30 includes: the RFID reader 31 for reading an ID code of the RFID tag 10; a time providing unit 33 for outputting the read time of the RFID tag 10 in synchronization with the ID code read time of the RFID reader 31; a position providing unit 34 for outputting the position of the RFID reader; a control unit 32 for performing an output/control operation for transmission by receiving the read ID code of the RFID reader 31, the output time of the time providing unit 33, and the output position of the position providing unit 34; a memory 35 for temporarily storing data output from the control unit 32; and a near-field communication unit 36 for transmitting the data to the central processing unit 60 in the near field.

Herein; if the RFID tag 10 is a :passive type, the RFID reader 31 outputs a frequency to supply power to the RFID tag 10. Accordingly, the RFID reader 31 receives data from the RFID tag 10 and provides the data to the control unit 32.

In order to receive the ID code read time of the RFID reader 31, upon receiving the ID code from the RFID reader 31, the control unit 32 synchronizes the time providing unit 33 to output the ID code read time.

The reason for this is that when the equipment with the RFID tag 10 attached obtains the passing time of the RFID reader 31, the RFID reader 31 can detect the start and end times of the equipment and can detect the operation time of the equipment for one process, thus making it possible to estimate the productivity. Therefore, a control operation is performed to output the time to read the RFID tag 10 by the RFID reader 31.

The position providing unit 34 provides the position of the RFID reader 31. If the tag data management device 30 is a stationary type, the position providing unit 34 prestores the corresponding coordinates. If the tag data management device 30 is a mobile type, the position providing unit 34 cannot accurately detect the coordinates and thus synchronizes in the same mechanism as the time providing unit 33 to output the coordinates.

Preferably, the time providing unit 33 and the position providing unit 34 may be integrated into a Global Positioning System (GPS).

It is preferable that the memory 35 is configured to temporarily store the read ID code of the RFID reader 31, the output time of the time providing unit 33, the output position of the position providing unit 34. The reason for this is that as the RFID tag 10 moves, the RFID reader 31 at the start or end point of each process cycle receives the contents of the RFID tag 10 in real time. Therefore, the transmission-completed data may not be stored any more, and thus it is preferable that the memory 35 is implemented using a flip-flop memory device Such as a Random Access Memory (RAM)

Since the remote-control central server 80 is located in the far field, the near-field communication unit 36 is provided to transmit data to the central processing device 60 located near to the construction work field.

Herein, it is preferable that the near-field communication unit 36 is implemented using a wireless LAN. The wireless LAN establishes a communication network using wireless transmission lines, such as electromagnetic waves or rays (infrared rays), and provides communication within a predetermined range. The wireless LAN can provide communication if only a wireless LAN card is installed in a personal computer (PC). Therefore, the near-field communication unit 36 is provided to transmit data to the central processing device 60 located in the near field.

For transmission of data from the near-field communication unit 36 to the central processing device 60, a wireless Access Point (AP) 40 is further provided to establish a wireless network within a predetermined range, so that the Internet can be used wirelessly within the predetermined range and the Internet service can be used through the LAN card within the network.

The central processing device 60 is provided to transmit data to the remote-control central server 80 located in the far field. It is preferable that the central processing device 60 is omitted if the near-field communication unit 36 of the tag data management device 30 is replaced by a CDMA module capable of transmitting data to the far field to directly transmit data from the tag data management device 30 to the remote-control central server 80.

If the central processing device 60 is omitted, it is preferable that, the wireless AP 40 for establishing the wireless Internet network is omitted.

Since the embodiment of the present invention exemplifies the case where the central processing device 60 is a personal computer (PC) not having the database 70 in the work field, it includes the central processing device 60 and the wireless AP 40.

Thus, the central processing device 60 includes: a long-distance communication unit 65 for transmitting data, received through the near-field communication unit 36 of the tag data management device 30, to the remote-control central server 80 located in the far field; and a control unit 63 for controlling them.

The near-field communication unit 61 may be used as a wireless LAN by having a wireless LAN card 61a, to which the present invention is not limited.

Herein, if a personal computer (PC) replaces the central 10 processing device 60 and can use the wired Internet, it is preferable that not the wireless long-distance communication unit 65 but the wired Internet network is used to transmit/receive data.

The remote-control central server 80 includes: a long-distance communication unit 81 for receiving data transmitted from the tag data management device 30 through the central processing device 60; and a control unit 83 for updating the cycle time of each equipment on the basis of data received from the long-distance communication unit 81, analyzing the corresponding productivity, and storing data in the database 70.

Herein, it is preferable that a memory 85 is further provided to store data temporarily between the control unit 83 and the database 70.

The database 70 is provided to store and update the respective data received through the tag data management device 30, the wireless AP 40, the central processing device 60 and the remote-control central server 80. The database 70 is provided to optimize and store the cycle time of each equipment for each process of construction work.

The database 70 is provided to update the time and position at the operation start point of each equipment having the RFID tag 10 attached thereto, to compare the update result with optimized data, and to output data, which are input in real time and exhibits lower productivity than the optimized data, to the user in order to eliminate a productivity-reducing factor.

The central server 50 can check the productivity in real time on the basis of respective data input in real time to the database 70, and can detect the difference from the target production yield by comparison with the optimized productivity.

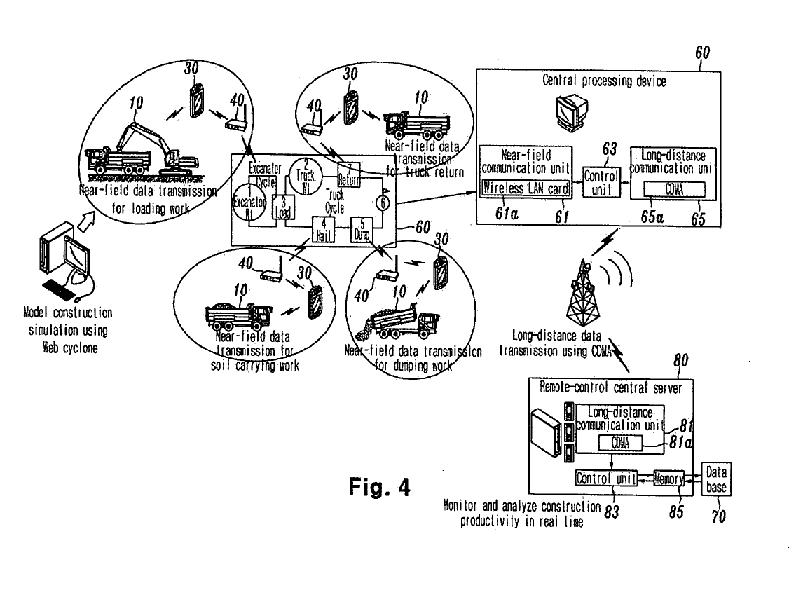

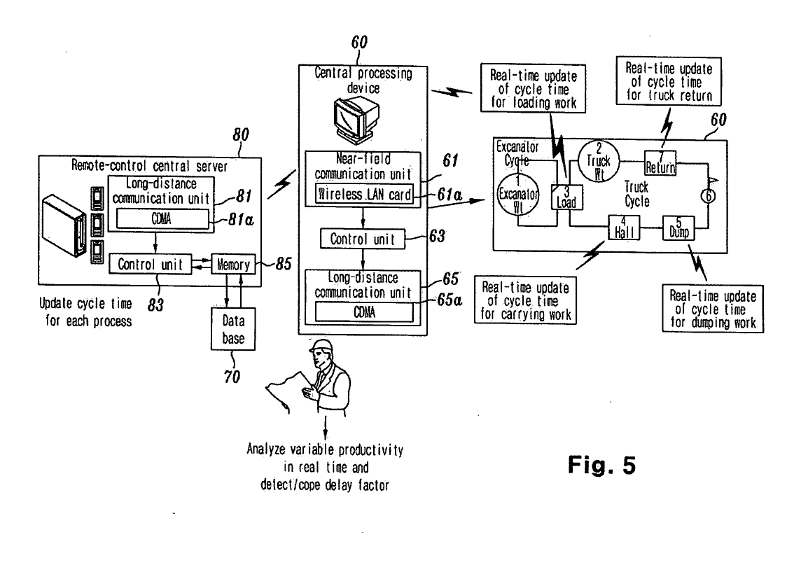

FIG. 4 is a schematic block diagram illustrating an operation process of the real-time construction productivity analyzing apparatus of FIG. 3. FIG. 5 is a schematic block diagram illustrating an operation process of the real-time construction productivity analyzing apparatus of FIG. 3.

Referring to FIGS. 3 to 5, the real-time construction productivity analyzing apparatus using an RFID based on wireless communication according to the present invention obverses and analyzes an accurate process for each process of construction work, resources such as equipments and workers, and a process cycle time to perform optimized modeling.

In other words, if a target process is determined for real-time construction productivity analysis, as the previous step for construction simulation modeling for the corresponding process, an accurate work process of the corresponding work is observed and measured, the corresponding detailed process steps are determined, and the work process is analyzed using the cycle time for each process and required resources such as the equipment for each of the determined detailed process step.

Then, the analyzed work process and related information are used to model a construction simulation using a Web cyclone, and it is preferable that the construction simulation modeling is performed on the basis of the programming for the Web cyclone and the overall technology related to the construction simulation modeling.

Also, the construction simulation using the Web cyclone is implemented, and information about a work process, a required resource and a cycle time is input on the basis of actual data of the field, which is prestored in the database 70 as standard data for comparison with real-time input data.

Then, according to the data calculated through the modeling and the actual data of the field, an the RFID tag 10 is attached to each equipment reducing the productivity, and an RFID reader 31 is installed to read an ID code of the RFID tag 10 in order to be able to check a cycle time of the equipment having the RFID tag 10 attached thereto. Herein, the RFID reader 31 is installed at the position capable of obtaining each process cycle time of each equipment having the RFID tag 10 attached thereto.

Thus, when the equipment having the RFID tag 10 attached thereto passes the position, the position and time information can be obtained by the RFID reader 31 through near-field data transmission using a wireless LAN. The RFID reader 31 may have a stationary installation position, or may have a mobile installation position if it is installed in an equipment such as a FDA.

Then, the ID code read by the RFID reader 31 and the time and position data are transmitted to the central processing device 60 (e.g., a main computer in a field office) through wireless communication including a wireless LAN.

Herein, the time information and the passing position of the equipment obtained through the RFID reader 31 are received through the wireless Internet network, and if the database 70 is located in the far field not in the field office, the passing position and time information are transmitted from the central processing device 60 to the database 70 through long-distance communication.

Herein, the long-distance communication is used to communicate data between the central processing device 60 and the remote-control central server 80 connected to the database 70 in the far field. The long-distance communication may be wired or wireless communication, and the embodiment of the present invention uses CDMA communication that is long-distance communication.

Thus, the data are transmitted to a field office with the database 70 or a remote management/control office with the database 70, the data are stored in the database 70, and the real-time productivity is output as the result in order to be able to detect the productivity that changes in real time according to a change in the cycle time.

Then, if the productivity data obtained in real time are lower than reference productivity data, it moves to a place where a productivity-reducing factor occurs to get the result for eliminating the productivity-reducing factor, and accordingly each equipment is controlled and managed to approach the target productivity.

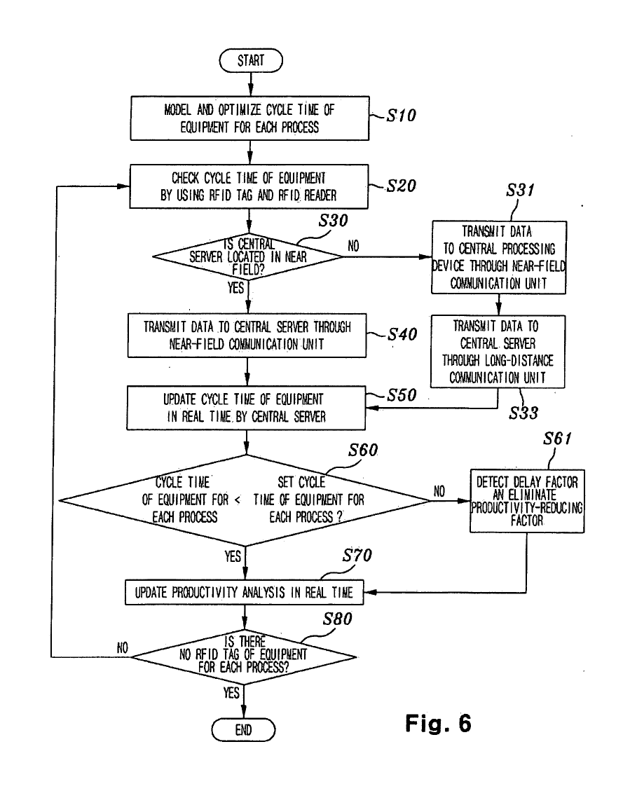

FIG. 6 is a flow diagram illustrating a real-time construction productivity analyzing method using an RFID based on wireless communication according to an exemplary embodiment of the present invention. Referring to FIG. 6, the present invention models a cycle time of each equipment for each process of construction work and optimizes the same to calculate reference data (S10).

Then, an RFID tag is attached to the productivity-reducing main equipment and an RFID reader is installed at each cycle start point and each cycle end point of each equipment for each process, so that the RFID reader 31 measures the cycle time and position every time when the equipment having the RFID tag attached thereto passes the cycle start point and the cycle end point.

Accordingly, every time when the equipment having the RFID tag attached thereto passes the installation point of the RFID reader 31, the ID code is detected to read in order to be able to a cycle time Of each equipment (S20).

Herein, whether the central server with the database is located in the near field is determined (S30), and if the central server with the database is located in the near field, the data are transmitted to the central server through the near-field communication unit (S40).

Meanwhile, if the central server with the database is not located in the near field, because the data must be transmitted to the database located in the far field, the near-field communication unit is used to transmit the data to the central processing device (S31) and the long-distance communication unit is used to transmit the data to the central server (S33). The near-field communication unit may be omitted and the long-distance communication unit may be used to directly transmit the data. The long-distance communication unit may use both wired communication and wireless communication.

Then, on the basis of the data received through the near-field communication unit or the long-distance communication unit, the central server updates the cycle time of the equipment in real time (S50), and it is used to compare the reference data prestored in the database with the real-time update data to inquire whether the productivity is lower than the reference data (S60).

If the productivity is lower than the reference data, because the productivity is poorer than the target productivity, productivity-reducing equipment and factor are detected and eliminated (S61). If the productivity is higher than the reference data, because the target productivity is being achieved, the real-time productivity analysis is updated (S70) and the algorithm according to the present invention is performed until the termination of the construction work (S80).

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

As described above, the real-time construction productivity analyzing apparatus using the RFID based on wireless communication according to the present invention analyzes the construction productivity in real time to implement a systematic construction management system, thereby making it possible to monitor the production yield for each process in real time to efficiently manage the construction work.

What is claimed is:

1. An apparatus for analyzing construction productivity in real time by using an RFID based on wireless communication, the apparatus comprising:
an RFID tag including an ID code for identification of each equipment for construction work and attached to each equipment;
a tag data management device for reading the ID code of the RFID tag in order to check a cycle time of each equipment in each process of the construction work, integrating the read time and position of the RFID tag and the ID code of the RFID tag, and transmitting the integrated data;
a central server for receiving the time and position data and the ID code data of the RFID tag from the tag data management device and updating the data in real time to monitor the productivity in real time; and
a database for storing the prestored data and the real-time input data of the central server.

2. The apparatus of claim 1, wherein
the tag data management device comprises a near-field communication unit for integrating the ID code of the RFID tag and transmitting the integrated data to the central server;
the central processing device comprises a long-distance communication unit for receiving the respective data from the tag data management device and transmitting the received data to the far field; and
the central server is located in the far field to update in real time the respective data received from the central processing unit to monitor the productivity in real time.

3. The apparatus of claim 2, wherein the tag data management device further comprises:
an RFID reader for reading the ID code of the RFID tag;
a time providing unit for outputting the ID code read time of the RFID tag RFID in synchronization with the RFID tag ID code read time of the RFID reader;
a position providing unit for outputting the RFID tag ID code read position in synchronization with the RFID tag ID code read time;
a memory for storing the ID code of the RFID tag, the output time of the time providing unit, and the output position of the position providing unit; and
a control unit for controlling the above components.

4. The apparatus of claim 2, wherein the central server comprises:
a control unit for receiving, data transmitted from the near-field communication unit of the tag data management device, outputting the received data to the database, and controlling the respective components.

5. The apparatus of claim 2, wherein
the central processing device further comprises a control unit thereof; and
the long-distance communication unit receives data transmitted from the near-field communication unit of the tag data management device and transmits the received data to the central server, and the control unit of the central processing device controls the respective components.

6. The apparatus of claim 2, further comprising:
a wireless access point installed to activate the central server, the central processing device, and the near-field communication unit of the tag data management device within a predetermined range.

7. The apparatus of claim 2, wherein the central server, the central processing device, and the near-field communication unit of the tag data management device use a wireless LAN.

8. The apparatus of claim 6, wherein the wireless access point is a wireless LAN wireless access point that enables the central server, the central processing device, and the near-field communication unit of the tag data management device to use a wireless LAN.

9. The apparatus of claim 1, further comprising:
a memory for temporarily storing data received from the control unit of the central server and data output from the database.

10. The apparatus of claim 1, wherein the database prestores: each ID code of each RFID tag, information about each equipment having the RFID tag attached thereto, and a reference cycle time pre-input by optimizing a cycle time of each equipment in each process; and updates the ID code of the RFID tag input in real time to the central server, the output time of the time providing unit, and the output position of the position providing unit.

11. The apparatus of claim 2, wherein the database prestores each ID code of each RFID tag, information about each equipment having the RFID tag attached thereto, and a reference cycle time pre-input by optimizing a cycle time of each equipment in each process; and updates the ID code of the RFID tag input in real time to the central server located in the far field, the output time of the time providing unit, and the output position of the position providing unit.

12. The apparatus of claim 2, wherein the long-distance communication unit of the central processing device and the central server located in the far field perform communication using CDMA.

13. A method for analyzing construction productivity in real time by using an RFID based on wireless communication, the method comprising:
modeling a cycle time of each equipment in each process of construction work and setting and inputting an optimized cycle time;
using an RFID tag and an RFID reader to check the cycle time of the equipment to discriminate between the respective equipments of the construction work;
if the RFID reader and a central server receiving data read by the RFID reader are located in the near field, transmitting the data to the central server through a near-field communication unit to update the cycle time of the equipment in real time; and
if the cycle time of the equipment is longer than the optimized cycle time, outputting data to eliminate a productivity-reducing factor to optimize the productivity.

14. The method of claim 13, wherein the transmitting of the data to the central server comprises:
if the central server receiving data read by the RFID reader is located in the far field, transmitting the data to a central processing device through a near-field communication unit; and
transmitting the data from the central processing device to the central server through a long-distance communication unit.

15. The method of claim 13, wherein the outputting of the data comprises:
if the cycle time of the equipment is smaller than the optimized cycle time, analyzing real-time productivity for each equipment in each process Of the construction work and updating the same.

16. The method of claim 13, wherein the near-field communication unit in the transmitting of the data to the central server uses a wireless LAN.

17. The method of claim 13, wherein the long-distance communication unit uses CDMA.
